(19) United States
(12) Patent Application Publication
(10) Pub. No.: US 2010/0074659 A1
(43) Pub. Date: Mar. 25, 2010

(54) IMAGE FORMING METHOD AND APPARATUS

(75) Inventor: Shoko Shimmura, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/563,538

(22) Filed: Sep. 21, 2009

Related U.S. Application Data
(60) Provisional application No. 61/099,721, filed on Sep. 24, 2008.

(51) Int. Cl. G03G 15/01

(52) U.S. Cl. 399/301

(57) ABSTRACT

In an electrophotographic color image forming system, including: forming a color image by transferring and superimposing toners of plural colors in a non-fixed state from an image holding member to an intermediate transfer member or a final transfer medium, wherein each toner and the image holding member are selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm². As a result, the controllability of the transfer characteristics by an electric field is improved while suppressing transfer residue and back transfer of a toner. Furthermore, by setting the value a/r showing the intensity of influence of the charge amount to the attachment force in a suitable range, the latitude of transfer conditions is enlarged, whereby favorable transfer characteristics can be maintained for a long period of time.

### CROSS REFERENCE TO RELATED APPLICATION

This application is based on and claims the benefit of priority from provisional U.S. Application 61/099,721 filed on Sep. 24, 2008, the entire contents of which are incorporated herein by reference.

### TECHNICAL FIELD

The present invention relates to an image forming method used for forming a color image by an electrophotographic process, such as a duplicator and a printer, and an apparatus therefor.

### BACKGROUND

A printing apparatus for forming a color image by electrophotographic process basically has four sets of developing devices each having developers of four colors, Y, M, C and K, respectively in the case of full-color printing. In the case where only one image holding member 10 is used as shown in FIGS. 1A and 1B, an electrostatic latent image corresponding to an image of the first color is formed on the image holding member 10, developed with toner particles T1 in the developing device D1 of the first color, and transferred to a transfer medium 30, which is conveyed between the image holding member 10 and a transfer roller 40 disposed at a position facing the image holding member 10 (FIG. 1A). An electrostatic latent image corresponding to an image of the second color is then formed on the image holding member 10, developed with toner particles T2 in the developing device D2 of the second color, and transferred with positional alignment to the transfer medium 30, on which the toner of the first color has already been transferred (FIG. 1B). Subsequently, toners of the third color and the fourth color are similarly transferred and superposed on the transfer medium 30 by the developing devices D3 of the third color and D4 of the fourth color. In the case where the transfer medium 30 is an intermediate transfer member, the toners of four colors are transported to a contact position with paper, etc. as a final transfer material (not shown), transferred to the paper at a time (secondary transfer step), and then subjected to a fixing step under heat and/or pressure to fix the toners to the paper, which is then discharged to the exterior of the apparatus. In the case where the transfer medium 30 is a final transfer member, such as paper, conveyed by a transfer medium conveying member, such as a transfer belt, the transfer medium 30 is released from the transfer belt and subjected, without the secondary transfer step, to a fixing step under heat and/or pressure to fix the toners to the paper, which is then discharged to the exterior of the apparatus. This method is referred to as a four-revolution process since only one image holding member is used and rotated four times to superpose toners of four colors by developing and transferring the toner of one color per one revolution, thereby forming a full color image. In the case where the same number of image holding members 11, 12, etc. are provided as the number of toners of four colors as shown in FIG. 2 (two developing units are omitted from showing in the figure), latent images are formed and developed with toners T1, T2, etc. substantially simultaneously with each other on the corresponding image holding members 11, 12, etc., respectively, and then sequentially transferred under synchronization to a final or intermediate transfer medium 30 conveyed with a transfer medium conveying member (not shown). The final transfer medium 30 is then released from the transfer medium conveying member, and in the case of the intermediate transfer member 30, the toner images are transferred at a time to a final transfer medium, and the final transfer medium is then subjected to a fixing step under heat and/or pressure to fix the toners on the paper, and discharged to the exterior of the apparatus. This method is referred to as a tandem process since four sets of image forming units are disposed in tandem along the conveying path of the transfer medium.

Compared with the four-revolution process, the tandem process has an advantage of a higher printing speed, but the apparatus therefor is liable to have a large size since it has four sets of image forming units. In the case where a monochrome image is printed with the tandem process, an apparatus therefor necessarily undergoes such procedures that image forming units of colors that are not used upon printing a monochrome image are, for example, stopped or retreated from the conveying path of the transfer medium, for preventing the devices and developers from being deteriorated. On the other hand, the four-revolution process can be easily specialized to monochrome image printing, and thus an apparatus for the four-revolution process is convenient for a user who prints monochrome images frequently. The intermediate transfer process enjoys large latitude for the final transfer media and is resistant to changes in temperature and humidity, but image deterioration associated with the transfer step occurs at least twice. The direct transfer process involves only one transfer step accompanied with image deterioration, but it is difficult to effect the transfer constantly with high accuracy and high image quality to final transfer media accompanied with various moisture contents and thicknesses. Furthermore, there are a contact developing process, in which a developer conveyed with a developer holding member contacts the image holding member at a developing nip part, and a non-contact developing process, in which a gap is maintained between a developer holding member and the image holding member, and toner particles are caused to flow under an electric field. The contact developing process can stably develop images while there is a possibility of disturbing a toner image formed on the image holding member.

As described above, there are various forms of apparatus for forming a full color image by the electrophotographic process, each of which has advantages and disadvantages, and printing apparatus can be composed by appropriately combining the forms, but problems of transfer residue and back transfer are common to the full color image forming apparatus.

Toner particles are attached imagewise to an image holding member 10 and then transferred to a facing transfer medium 3 under a force of an electric field, but it is difficult to transfer the particles completely. Not-transferred toners T1R, T2R, etc. are removed with a cleaning member on the image holding member, and then discarded or reused after returning to a developing device. For returning and reusing the toner, it is necessary to convey the transfer-residual toner to the developing device, thus requiring a complicated structure of the apparatus, and the transfer-residual toner may have a charge amount that is different from the fresh toner, which provides a possibility of deterioration in image quality. In the case where the transfer-residual toner is discarded, these problems are not encountered, but the discarding operation is necessarily performed by a user or a service person, which is not desirable from the standpoint of operation cost and environment. For solving the problems, a “simultaneous developing and cleaning process” has been proposed, in which the transfer-residual toner is not cleaned with a special recovering device but is recovered in the developing device simultaneously with developing. In this process, however, when the amount of the transfer-residual toner is large, exposure in the next step may be impaired thereby, and a ghost image of the previous image may appear on the next image due to, e.g., insufficient recovery of the transfer-residual toner to the developing device.

In the intermediate transfer process, in which a toner is transferred from an image holding member to an intermediate transfer member and then secondarily transferred to a final transfer medium, there is a high possibility that a non-transferred toner remains on the intermediate transfer medium, and it is necessary to clean the transfer-residual toner on the intermediate transfer medium. Particularly, when a full color image is printed, toners of plural colors are transferred and superposed on an intermediate transfer member, and upon transferring at a time the toners in a multi-layer form, a larger amount of the toners are caused to remain without transfer compared with the case of monochrome printing.

Furthermore, upon transferring a toner from an image holding member to an intermediate transfer member or a final transfer medium, the toners of four colors are transferred and superposed sequentially in a non-fixed state, and thus there is a problem that toner particles transferred in the preceding step onto the transfer member are attached as back-transferred toners T1B, T2B, etc. to an image holding member 10 upon transferring the toner of the next color (back transfer) which phenomenon tends to be increased when the toner layer becomes thicker. When the phenomenon occurs, not only the amount of the toner forming the image is decreased to deteriorate the image quality, such as deterioration in reproducibility of thin lines and edges and change in colors, but also in the case, for example, where toners of Y, M, C and K are transferred to a transfer medium 3 in this order as in a tandem system shown in FIG. 7, after primarily transferred, the transfer-residual M toner T2R and the back-transferred Y toner T1B are attached to the M image holding member 1M, the transfer-residual C toner T3R and the back-transferred Y and M toners T1R and T2R are attached to the C image holding member 1C, and the transfer-residual K toner T4R and the back-transferred Y, M and C toners T1R, T2R and T3R are attached to the K image holding member 1K, whereby the toners cannot be returned to the developing devices for reusing.

Accordingly, it is necessary to design the materials and the apparatus in such a manner that toner particles are surely moved in one direction of from an image forming member (via an intermediate transfer member) to a final transfer medium, without being moved in the reverse direction. Toner particles are attached to a member to be attached by an electrostatic force and a non-electrostatic force, and are moved due to electric charge thereof by applying an electric field to the transfer nip. Therefore, it is very important to control the attachment forces of the toner particles to the toner particles, the image holding member, the intermediate transfer member, the final transfer medium, etc.

For enhancing the transfer efficiency by controlling an attachment force of a toner, JP-A-2003-098847 proposes an image forming apparatus, in which the attachment force between the individual toner particles is larger than the attachment force between the toner and the intermediate transfer member, and is larger than the attachment force between the toner and the recording material. The proposed technique is made based on such recognition that the attachment force of the toner is not changed even when the toner charge amount is changed. However, the attachment force is composed of a non-electrostatic attachment force, which is not fluctuated by the charge amount, and an electrostatic force, which is proportional to square of the charge amount, and thus when the toner charge amount is changed by occurrence of discharge, etc., the attachment force is definitely changed. The attachment force between the toner particles is very largely influenced relatively by the non-electrostatic attachment force since the contact surface area are very large, and the electrostatic force functions as a repulsive force since the individual toner particles basically have the same polarity. Accordingly, the influence of the change in toner charge amount on the attachment force between the toner particles is entirely different from the influence on the attachment forces of the toner to the image holding member, the intermediate transfer member, the recording material, etc., and the apparatus also involves a drawback (problem) that it cannot cope with the change of the toner charge amount.

### SUMMARY

An object of the invention is to provide an image forming method with improved controllability of transfer property by an electric field and capable of suppressing transfer residue (non-transfer) and back transfer (reverse transfer) of a toner, by taking change in an attachment force accompanying change in a charge amount of the toner into consideration and based thereon, by setting the relationship between the charge amount of the toner and change in the attachment force within a limited range even though the development level varies, and to provide an apparatus for the image forming method.

The invention relates to, according to one aspect, an electrophotographic color image forming method comprising: forming a color image by transferring and superimposing toners of plural colors in a non-fixed state from an image holding member to an intermediate transfer member or a final transfer medium, wherein each toner and the image holding member are selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm². FIG. 10 is a graph showing an example of the relationship between the attachment force F and the square of the charge amount q² that satisfies the conditions of the invention.

It is preferred in the method of the invention that each toner and the image holding member are selected to further satisfy a relationship of 0.4≦a/r≦0.8 where an average value Fe of an electrostatic attachment force between the image holding member and the toner is expressed by a following formula (2):

$${F}_{e} = \frac{{ɛ}^{′} - 1}{{ɛ}^{′} + 1} \cdot \frac{{q}^{2} {r}^{2}}{4 π {{ɛ}_{0} ( {r}^{2} - {a}^{2} )}^{2}} \qquad ( 2 )$$

wherein ∈′ represents a relative dielectric constant of the image holding member, q represents a charge amount (C) per one particle of the toner, and r represents a 50% number average radius of the toner (m).

The invention also relates to, according to another aspect, a color image forming apparatus comprising a rotating image holding member, and a charging unit, an imagewise exposing unit, developing units and a transferring unit that are disposed around the image holding member in this order; the developing units including Y, M, C and K developing units that form Y, M, C and K toner images, respectively, by developing electrostatic images on the image holding member with Y, M, C and K toners in association with rotation of the developing unit and the image holding member; wherein each toner and the image holding member are selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm².

The invention also relates to, according to still another aspect, a color image forming apparatus comprising four image forming units including a Y image forming unit, an M image forming unit, a C image forming unit and a K image forming unit, and a transferring unit; each image forming unit including an image holding member, a charging unit, an imagewise exposing unit and a developing unit for forming a toner image of a corresponding color on the image holding member; the transferring units transferring and superposing Y, M, C and K toner images, which are formed on the respective image holding members, in a non-fixed state onto a transfer medium; and in each of the image forming units, the toner and the image holding member are selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm².

The inventor made various investigations shown below for solving the problems, thereby achieving the invention.

In an electrophotographic color image forming method and an apparatus therefor, it is necessary to decrease both transfer residue and back transfer of a toner. This is particularly important in a cleanerless process. A high transfer efficiency can be expected by applying a necessary transfer electric field, but there is a tendency that the back transfer amount is increased with the optimum forward transfer electric field in most toners (see the transfer condition 1 in FIG. 3). In a cleanerless process, when a back-transferred toner of different color is recovered in a developing device, the color of the toner in the developing device is changed to fail in controlling accurately color reproducibility of a full color image. Accordingly, in order to decrease the back transfer amount preferentially to the transfer residue amount, it is necessary that the toner is transferred under a lower electric field (necessary electric field) than the optimum transfer electric field (see the transfer condition 2 in FIG. 3).

The necessary transfer electric field referred herein is described in detail. Toner particles are attached to a member to be attached (for example, an image holding member) through an attachment force F, and the toner particles are transferred from the member to be attached to a transfer medium under the action of a force of an electric field that is larger than the attachment force F in the direction toward the transfer medium. The force applied to the particle by the electric field is E×q. Accordingly, the necessary electric field E is determined by E×q>F, i.e., E>F/q. A larger necessary electric field E results in a larger transfer residue amount. This is because discharge (denoted by DSN in FIG. 2) is more liable to occur in the vicinity of the nip when the electric field applied is higher, and the toner particle having received the discharge from the transfer surface is reversed in charge polarity and thus cannot be transferred.

It is necessary that the proportionality factor K of the electrostatic attachment force is small in order that the change amount of the necessary transfer electric field is small even when the toner charge amount is fluctuated due to deterioration with time, environmental change, etc.

The back transfer amount under the necessary electric field is roughly determined by the number of layers, the development toner charge amount Q/M and the width of particle size distribution. The back transfer amount is increased at a larger number of layers, at a smaller charge amount, and at a broader particle size distribution. However, the back transfer amount can be decreased by using toner particles having an attachment force between the toner particles per se which is nearly equal to the attachment force between the toner and the image holding member.

An attachment force F1 between a toner and an image holding member is obtained as an average attachment force F measured in such a manner that the toner in an amount corresponding to one layer or less is attached to a photoconductor sheet, and the average attachment force F is measured by a centrifugal method as described later. A relationship between an attachment force F2 between individual toner particles and the F1 can be obtained from an average attachment force F3 measured under the condition that the toner in an amount larger than corresponding to one layer is attached to a photoconductor sheet, and an average attachment force is measured by the centrifugal method. F3 is a composite value of F1 and F2, and since the average attachment force is calculated from a ratio of the amount of the toner that is released by the centrifugal force to the amount of the toner that is not released, a relationship F1>F3 is obtained in either case of F1<F2 or F1>F2. A relationship F1≈F3 is obtained only when F1≈F2 (wherein≈represents nearly equal). The attachment force F is the sum of the electrostatic force and the non-electrostatic attachment force. The electrostatic force is expressed by (square of the charge amount q)×(proportionality factor), and the non-electrostatic attachment force depends on the contact area. With respect to the attachment force between the toner particle and the image holding member, the electrostatic force acts between the charge of the toner and the mirror charge induced on the surface of the image holding member, and is an attractive force as the polarities are opposite to each other. The contact area depends on the shape of the particles, and is smaller when the surface of the particle is smoother, the shape is closer to a true sphere, and the particle diameter is smaller. With respect to the attachment force between the toner particles, an electrostatic force is generated between charges held by individual particles. Particles are considered to have charges non-uniformly distributed in proximity to the surfaces, and an attachment force is caused between charged surfaces of different polarities and between a charged surface and a non-charged surface. The non-electrostatic attachment force is larger when the contact area is larger, and when the number of the particles is larger, the number of the particles present in the neighborhood is increased, and the contact area is increased. The particles are packed more densely, when the particle diameter is more uniform, the surface is smoother and is closer to a spherical shape, and the spacer effect owing to an external additive is smaller, so that the contact area is increased, and the attachment force is increased.

An ordinary toner contains a large amount of an external additive added for enhancing the fluidity of the developer, has a particle size distribution, and is low in packing factor since unevenness is imparted to the particle shape for performing blade cleaning effectively, thereby decreasing the attachment force between the toner particles. For increasing the attachment force between the particles to a level nearly equal to the attachment force between the toner and the image holding member, it is necessary to increase the contact area among the toner particles as by narrowing the particle diameter distribution, smoothing the shape of the particle surface, etc., but it is not desirable that the contact area is excessively increased since the attachment force between the particles becomes relatively larger.

When the attachment force between the toner particles is larger than the attachment force between the image holding member and the toner, in the case where the charge of the toner is reversed by discharge generated in the vicinity of the transfer nip, a large number of the particles are moved along with the toner particles attracted to the side of the image holding member under the force of the electric field, thereby further increasing the back transfer amount. On the other hand, when the attachment force between the toner particles is smaller than the attachment force between the image holding member and the toner, it becomes difficult for the toner particles having a decreased charge amount, if not to have a reverse polarity, to receive the fore of the electric field functioning in the direction toward the transfer medium, so that the toner particles are attracted upon contact with the image holding member to the mirror charge generated on the image holding member but not to the toner particles of the same polarity present in the neighborhood, thereby causing back transfer. In the case where the attachment force between the toner particles and the attachment force between the image holding member and the toner are substantially equal to each other, however, the toner particles are not dragged due to excessive constraint by a small amount of particles with the reversed polarity, as in the case when the attachment force to the particles in the neighborhood is large, nor are they attracted by the attachment force generated with respect to the image holding member in contact therewith again due to the too weak attachment force to the particles in the neighborhood, but the toner particles can be moved according to the applied electric field.

The factors that change the balance between the attachment forces are difficult to control accurately in the case of a complex powder material, such as toner particles, etc., and it is substantially impossible to design the factors based on theories. In an actual printing apparatus, it is inefficient to confirm how the toner charge amount is changed by influences of the process steps, the time lapse change and the environmental temperature and humidity, by confirming the transfer characteristics while reproducing all these conditions. In the present invention, however, the attachment force is measured, and the relationship between the attachment force F and the charge amount q² is provided in that the difference from the primary approximate expression falls within 10% or less in a range of the toner developed amount of from 150 to 600 μg/cm², whereby a printing method and an apparatus therefor with a small amount of a back-transferred toner can be obtained.

In the above-mentioned relationship 0.4≦a/r≦0.8 of formula (2), a is a value showing homogeneity of the charge present on the toner particle. When a=0, i.e., the charge is completely uniform, the relationship is reduced to a theoretical expression of an image force acting between a toner particle and an image holding member through the toner charge. a/r<0.4 means the absence of a charge localized on the toner particle surface and toner particles of the same polarity opposing each other do not cause an attachment force, i.e., an attractive force, so that they cannot be present adjacent to each other. This is a state where the development amount cannot be increased to a level providing a sufficient image density. On the other hand, when a/r exceeds 0.8, the charge distribution becomes remarkably non-uniform to increase fluctuation in image force, whereby the necessary transfer electric field is fluctuated upon fluctuation of the charge amount q, so that it becomes difficult to maintain high transfer efficiency. Accordingly, when the value a satisfies the relationship 0.4≦a/r≦0.8, the change amount of the attachment force due to change in charge amount can be small, and even when the toner charge amount is fluctuated due to such factors as discharge generated in the vicinity of the nip, change in environmental temperature and humidity, fluctuation of the mixing ratio of the toner and the carrier, fluctuation in friction number due to insufficient agitation of the toner and the carrier, etc., the necessary transfer electric field is not deviated to a large extent, thereby further facilitating maintenance of the high transfer efficiency.

### DESCRIPTION OF THE DRAWINGS

FIGS. 1A and 1B are schematic cross sectional views showing an example of a part of a structure of an image holding member and a transfer medium of a four-revolution process. FIG. 1A shows a state where a first toner is developed onto the image holding member and transferred to the transfer medium, and FIG. 1B shows a state where a rotary developing device is rotated by a ¼ turn to make a developing device housing a second toner face the image holding member, and the second toner is developed onto the image holding member and transferred to the transfer medium.

FIG. 2 is a schematic cross sectional view showing an example of a part of a structure of an image holding member and a transfer medium for a tandem process, and shows movement (transfer) of a toner, generation of discharge before and after the nip, a transfer-residual toner and a back-transferred toner.

FIG. 3 is a graph showing an example of data of a transfer residue amount and a back transfer amount of toner particles versus a transfer electric field.

FIG. 4 is a schematic cross sectional view showing an example of an electrophotographic process, to which the invention is applied, including a printing unit for an N-th color, a primary transfer unit to an intermediate transfer medium, and a secondary transfer unit to a final transfer medium, in a color image forming apparatus.

FIG. 5 is a schematic cross sectional view showing an example of an electrophotographic process, to which the invention is applied, including a printing unit for an N-th color, and a direct transfer unit to a final transfer medium, in a color image forming apparatus.

FIG. 6 is a schematic cross sectional view showing an example of an image forming apparatus, to which a cleanerless process according to the invention is applied, having a pair of brushes having functions of ghost image prevention, primary recovery and toner charging.

FIG. 7 is a schematic cross sectional view showing an example of a structure of a full color image forming apparatus of a tandem-type, to which the invention is applied.

FIGS. 8A and 8B are a perspective view and a cross sectional view, respectively, of an angle rotor for an ultracentrifuge, to which a sample plate having toner particles attached, used for measuring the attachment force of the toner.

FIGS. 9A and 9B are a perspective exploded view and a cross sectional view, respectively, wherein FIG. 9A is a perspective exploded view of the cell used for mounting a sample plate having toner particles attached to an ultracentrifuge, and FIG. 9B is a cross sectional view of the rotor in which the cell is disposed.

FIG. 10 is a graph showing an example of relationship between a charge amount q and an attachment force F of toner particles that satisfy the condition of the invention.

FIG. 11 is a graph showing measurement data showing the relationship between the charge amount and the attachment force in Example 1.

FIG. 12 is a graph showing the transfer characteristics when the developer of Example 1 is used.

FIG. 13 is a graph showing measurement data showing the relationship between the charge amount and the attachment force in Comparative Example 1.

FIG. 14 is a graph showing the transfer characteristics when the developer of Comparative Example 1 is used.

FIG. 15 is a graph showing the data in Table 3.

FIG. 16 is a graph obtained by plotting the range of the necessary transfer electric field (of from the upper limit value to the lower limit value) upon fluctuation of the toner charge amount with respect to the gradient a/r of the attachment force.

FIG. 17 is a graph showing the transfer residue and back transfer characteristics in Comparative Example 3.

FIG. 18 is a graph showing the relationship between the a/r values and the minimum transfer residue ratio of each developer.

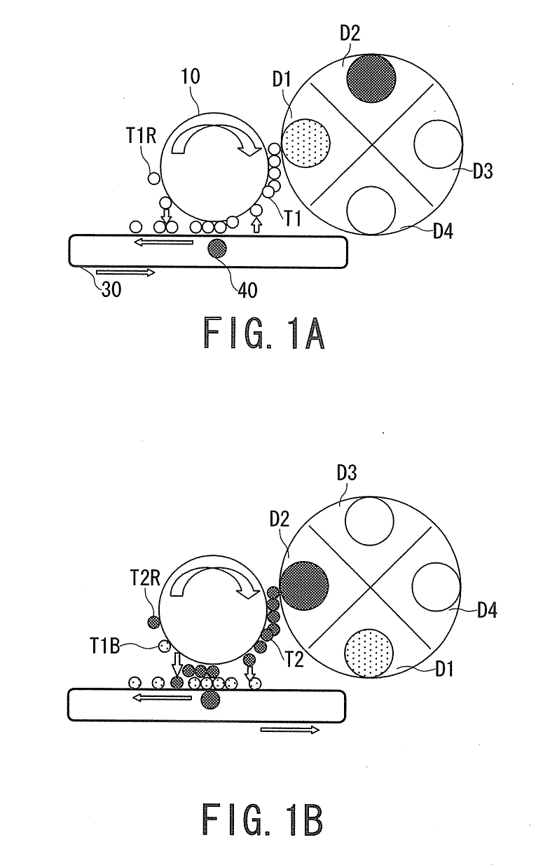

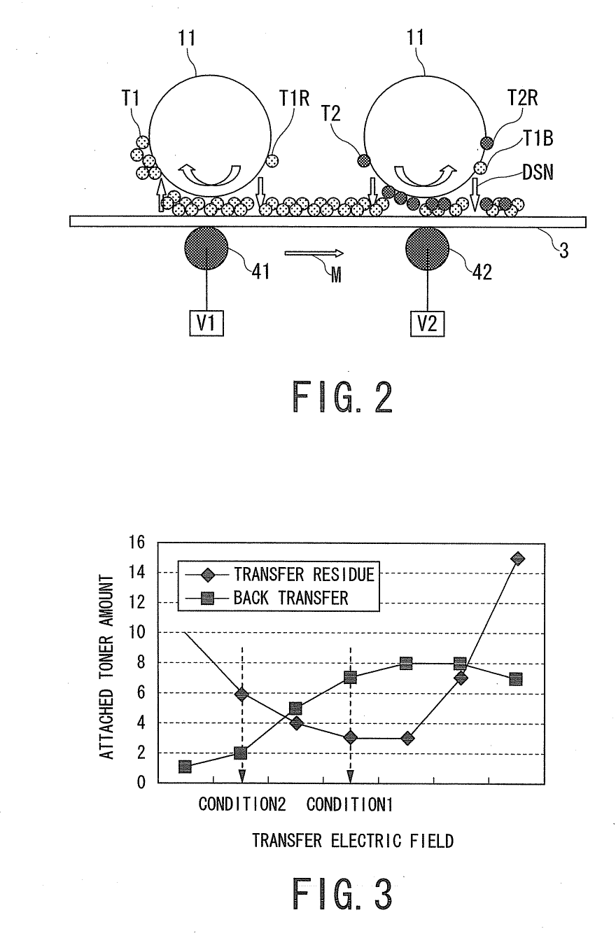

### DETAILED DESCRIPTION

Embodiments of the invention will be described.

### (Electrophotographic Developing Process)

The toner may have a known composition and composed with a binder resin (a polyester resin, a styrene-acrylic resin, a cyclic olefin resin, etc.), a colorant (a known pigment, such as carbon black, a condensed polycyclic pigment, an azo pigment, a phthalocyanine pigment, an inorganic pigment, etc., a dye, etc.), wax (synthetic wax, such as polyethylene series, polypropylene series, etc., petroleum wax, such as paraffin series, microcrystalline series, etc., or vegetable wax, such as rice wax, carnauba wax, etc.) as a fixing assistant, a charge controlling agent (CCA), etc., to which inorganic fine particles for improving the fluidity (silica, alumina, titanium oxide, etc.), organic fine particles for the same purpose, etc. are externally added, and is produced by pulverization or a chemical production method. The volume average particle diameter is from 3 to 8 μm, and desirably from 4 to 6 μm.

In the case of two-component development, the carrier may be a known magnetic carrier, such as ferrite, magnetite, iron oxide, resin particles having magnetic powder mixed therein, etc., and may have a resin coating (a fluorine resin, a silicone resin, an acrylic resin, etc.) on the whole or a part of the surface thereof. The volume average particle diameter is from 20 to 100 μm, and more desirably from 30 to 60 μm. Other changes may be made unless the gist of the invention is impaired.

### (Image Forming Process)

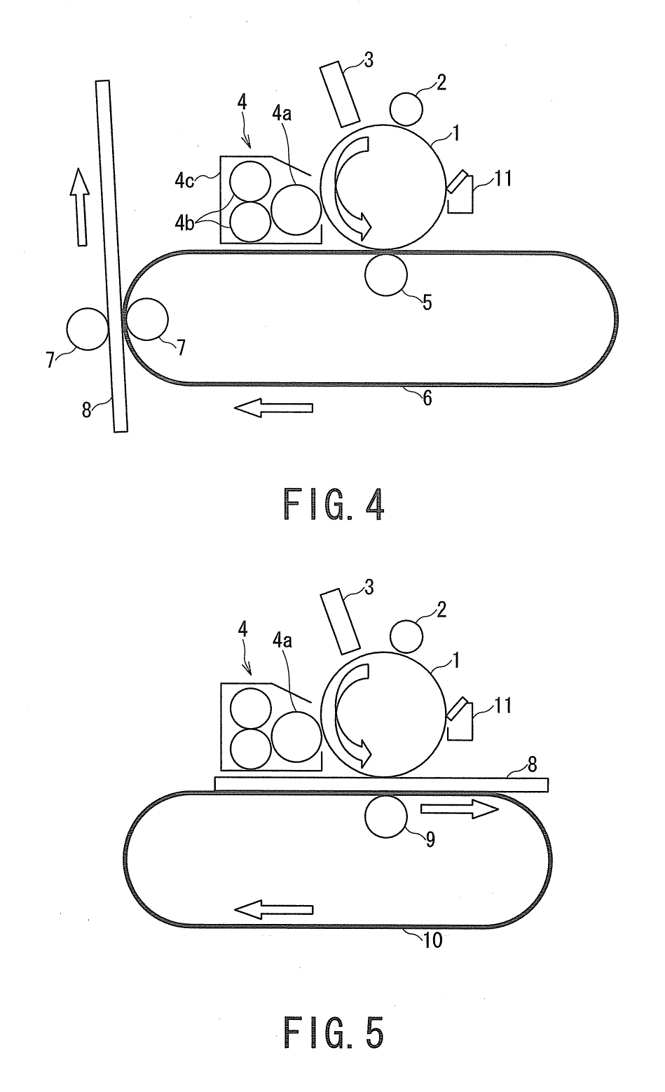

FIG. 4 is a schematic cross sectional view showing an example of an electrophotographic process, to which the invention is applied, including a printing unit, a primary transfer unit to an intermediate transfer medium, and a secondary transfer unit to a final transfer medium for an N-th color in a color image forming apparatus. As shown in FIG. 4, an image holding member 1 of an N-th image containing a belt, a roller, etc. is charged uniformly to a desired potential with a known charging device 2, such as a non-contact charging device, e.g., a corona charging device (a charging wire, a comb charger, a scorotron, etc.) and a non-contact charging roller, and a contact charging device, e.g., a contact charging roller, a magnetic brush, an electroconductive brush and a solid charger. The image holding member 1 may comprise a known photoconductor, such as OPC, amorphous silicon, etc., that is positively charged or negatively charged, in which a charge generating layer, a charge transporting layer, a protective layer, etc. may be laminated, or a single layer may have the plural functions of the layers.

An electrostatic latent image is formed on the image holding member 1 with a known exposing device 3, such as laser, LED and a solid head. A two-component developer layer containing a charged toner is formed on a developer holding member (developing roller) 4a including a magnetic roller by the N-th developing device including the developing roller 4a, and the two-component developer is conveyed to the developing position facing the image holding member 1, thereby visualizing the electrostatic latent image on the image holding member by feeding the charged toner by magnetic brush developing. The developing roller 4a is supplied with a developing bias forming an electric field, by which the development toner is attached to the electrostatic latent image. The developing bias may comprise DC, optionally superposed with AC, for attaching the toner particles uniformly and stably to the surface of the photoconductor.

The toner image thus formed on the image holding member 1 is transferred to an intermediate transfer means (such as a belt and a roller) with a known transfer unit 5, such as a transfer roller, a transfer blade and a corona charger, and then transferred to a final transfer medium 8, such as paper, conveyed from a transfer medium feeding device (not shown), under action of a known secondary transfer unit 7 including a known transfer unit. The transfer medium 8 having the toner image transferred thereon is conveyed to a fixing unit (not shown), and the toner image is fixed by a known heat and pressure fixing process, such as a heat roller, and then delivered to the exterior of the apparatus.

FIG. 5 is a schematic cross sectional view showing another example of an electrophotographic process, to which the invention is applied, in which a printing unit, a direct transfer unit to a final transfer medium for an N-th color in a color image forming apparatus. In the process shown in FIG. 5, a toner image formed on an image holding member 1 is transferred under the action of a transfer member 9 to a final transfer medium 8 conveyed with a transfer medium conveying device 10 without an intermediate transfer member, followed by fixing. The other part of the process shown in FIG. 5 is the same as the process shown in FIG. 4.

In both processes shown in FIGS. 4 and 5, after transferring the toner image to the intermediate transfer medium 6 or the direct transfer medium 8, the transfer-residual toner remaining on the image holding Member 1 is removed by a cleaning device 11, and the electrostatic latent image on the image holding member 1 is removed with a charge-removal device (not shown). The transfer-residual toner removed with the cleaning device 11 is conveyed in the conveying path with an auger, etc., stored in a waste toner box, and then discharged. Alternatively, the transfer-residual toner may be recovered in the developer container of the developing device 4 through the conveying path (recycling process).

The developing device 4 may contain from 100 to 700 g of a two-component developer comprising a carrier and a toner in a hopper. The developer is conveyed with an agitation auger 4b to the developing roller 4a, and after losing a part of the toner through development, released from the developing roller 4a at a releasing position of the magnetic roller in the developing roller 4a, followed by returning to the developer container 4c with the agitation auger 4b. The developer container 4c equipped with a known toner concentration sensor, and when the concentration sensor detects decrease of the toner amount, a signal is sent to the toner supplying hopper, and a replenishing toner is supplied. A consumed toner amount may be estimated from the accumulation of printed data and/or the amount of the toner developed on the photoconductor, and a replenishing toner may be supplied based thereon. Both the sensor output and the estimation of the consumed amount may be employed. Such a process may be employed that a replenishment carrier is supplied little by little simultaneously with or separately from the replenishing toner, and the developer is discarded little by little, thereby replacing the developer automatically.

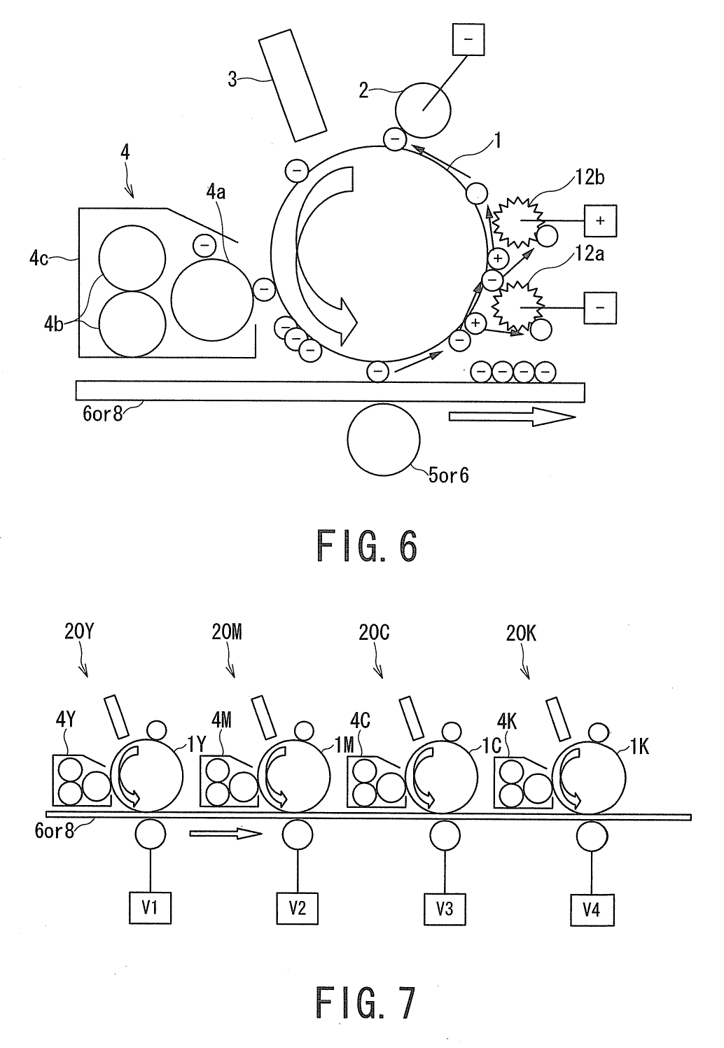

In the case of a cleanerless process including no cleaning device as shown in FIG. 6, an image holding member 1 is charged, exposed, and then developed with a toner, and the toner image is transferred to an intermediate transfer medium 6 or a direct transfer medium 8. Thereafter, the transfer-residual toner remaining on the image holding member is again conveyed to the developing zone for a next image forming cycle including charge-removal, charging and exposing, and the toner remaining on the non-image part of the next image is recovered in the developing device 4 with a magnetic brush as a developer holding member. A ghost image preventing member, such as a fixed brush, felt, a rotating brush and a transversely rubbing brush, may be disposed on the image holding member 1 before or after charge-removal the electrostatic latent image. It is also possible to dispose a temporary recovering member for once recovering the residual toner discharging again to the image holding member and then recovering it in the developing device. Furthermore, for adjusting the charge amount of the transfer-residual toner on the photoconductor to a desired value, a toner charging device may be provided. A part or the whole of the functions of the toner charging device, a ghost-image preventing member, the temporary recovering member and the photoconductor-charging member can be performed with one member. These members may be supplied with a positive and/or negative DC and/or AC voltage for performing the functions thereof efficiently. In the process shown in FIG. 6, the first transversely rubbing brush 12a and the second transversely rubbing brush 12b are provided for ghost image prevention, primary recovery of the residual toner and adjustment of the charge amount of the residual toner. The process shown in FIG. 6 is identical to the processes shown in FIGS. 4 and 5 except that no cleaning device is provided so as to perform a simultaneous developing and cleaning process.

FIG. 7 is a schematic cross sectional view showing an embodiment of a full color image forming apparatus of a four-step tandem process, to which the invention is applied. The image forming apparatus has image forming units of four colors each containing a developing device including a toner of yellow (Y), magenta (M), cyan (C) or black (K), an image holding member, and charging, exposing and transferring devices, and the image forming units are arranged in series along a conveying path of a transfer medium. The transfer medium may be either a direct transfer medium 8 or an intermediate transfer medium 6. A case where yellow, magenta, cyan and black colors are arranged in this order is described below for example.

As shown in FIG. 7, a yellow toner image is formed on a photoconductor 1Y in the yellow image forming unit 20Y, and transferred to the transfer medium 6 or 8. In the case of direct transfer, paper, etc. as the final transfer medium 8 is conveyed with a conveying member, such as a transfer belt or a roller, and fed to the transfer zone of the yellow image unit 1Y. The material for the transfer belt (not shown) may be rubber, such as EPDM, CR rubber, etc., or a resin, such as polyimide, polycarbonate, PVDF, ETFE, etc. The volume resistance thereof is desirably from 10⁷ to 10¹² Ωcm. In the case of intermediate transfer, an intermediate transfer medium 6 in the form of a belt or a roller is disposed to pass through the transfer zones of the image forming units. The surface resistance of the intermediate transfer belt is desirably from 10⁷ to 10¹² Ωcm, and was 10⁹ Ωcm in a specific embodiment. The material therefor may be rubber, such as EPDM and CR rubber, or a resin, such as polyimide, polycarbonate, PVDF and ETFE. The intermediate transfer belt may be composed of a single layer or a laminate of two or more layers each of a resin sheet, a rubber elastic layer, a protective layer, etc. The transfer process may be performed by a known transfer means, such as a transfer roller, a transfer blade and a corona charger.

A magenta toner image is similarly formed on a photoconductor 1M in the magenta image forming unit 20M, the transfer medium 6 or 8 having a yellow toner image already transferred thereon is fed to the transfer zone of the magenta image forming unit, and the magenta toner image is transferred on and in alignment with the yellow toner image. At this time, the yellow toner on the transfer medium contacts the magenta photoconductor, thereby providing a possibility that a slight portion of the yellow toner is back-transferred to the magenta photoconductor depending on the toner charge amount and the intensity of the transfer electric field, but substantially no back transfer occurs with the toner particles that have the characteristics according to the invention.

Subsequently, toner images are similarly formed in the cyan image forming unit 20C and the black image forming unit 20K, and transferred and superposed sequentially on the transfer medium. There is a possibility that a slight portion of the toner of the preceding step is back-transferred to the cyan and black photoconductors (the yellow and magenta toners to the cyan photoconductor 1C, and the yellow, magenta and cyan toners to the black photoconductor 1K), but substantially no back transfer occurs with the toner particles that have the characteristics according to the invention.

In the case where the transfer medium 6 or 8 having the toners of four colors superposed thereon is a final transfer medium 8, the transfer medium 8 is released from the conveying member and conveyed to a fixing section, in which they are fixed by a known heat and pressure fixing means, such as a heat roller, and then discharged out of the apparatus. In the case where the transfer medium is an intermediate transfer medium 6, the toner images of four colors are transferred at a time onto a final transfer medium 8, such as paper, etc., fed by secondary transfer means (corresponding to the secondary transfer means 7 in FIG. 4), and the transfer medium 8 is conveyed to a fixing section, in which they are fixed similarly, and then discharged out of the apparatus.

As described in the process of FIG. 4, in each of the image forming units, the photoconductor (1Y, 1M, 1C or 1K) is returned to an image forming cycle through charge-removal, cleaning, etc., and a relative concentration of the toner in the developing device (4Y, 4M, 4C or 4K) is adjusted as desired. An example where image forming units of yellow, magenta, cyan and black are arranged in this order has been described herein, but the order of the colors is not limited.

In the case of a four-step tandem cleanerless process as shown in FIG. 7, toners of four colors are fixed on a final transfer medium in a process similar to the above, but a device for cleaning the transfer-residual toner and the back-transferred toner on the photoconductor is not provided. At least one of a ghost image-preventing member, a temporary recovering member and a toner charging device may be provided as in the embodiment shown in FIG. 6. A single member may also have one or more functions of other members. For example, as shown in FIG. 6, two transversely rubbing brushes 12a and 12b that have all the functions of the three members are provided between the transfer zone and the photoconductor charging member in such a manner that the tip of the brush contacts the photoconductor, and the brush 12a on the upstream side is supplied with a voltage of the same polarity as the development toner, whereas the brush 12b on the downstream side is supplied with a voltage of opposite polarity from the development toner. The transfer-residual toner contains a toner of the opposite polarity and a toner having an extremely high potential of the same polarity in mixture, and the toner of the opposite polarity contacting the brush 12a of the same polarity is reversed in polarity and slips through the brush or is once recovered by the brush. The transfer-residual toner reaching the brush 12b of the opposite polarity has entirely the same polarity as the development toner, and upon contacting the brush of the opposite polarity, the strong charge of the same polarity is attenuated, whereby the toner slips through the brush or is once recovered by the brush. The transfer-residual toner having a weak charge amount or having lost image structure due to mechanical contact with the brush, is charged along with the photoconductor with a contact or non-contact photoconductor charging member, thereby having a charge amount equivalent to the development toner. Consequently, in the developing region, the transfer-residual toner in a non-image area of a subsequent latent image is recovered in the developing device 4, and the transfer-residual toner in an image area is transferred to a transfer medium along with a fresh toner fed from the developing device 4. As having been described, the transfer-residual toner is adjusted in charge amount and recovered in the developing device 4. In the case of a four-step tandem apparatus, however, when the toner of the color of the preceding step is back-transferred, the toner is also recovered in the developing device, thereby providing a problem that the color tone of the toner in the developing device is changed when the back transfer amount is large. However, the use of the developer of the invention suppresses the back transfer amount considerably small, and thus the problem of color mixing can be considerably alleviated. Simultaneously, in the case where the transfer residue amount is large, there is a possibility that the amount of the toner that is temporarily recovered by the ghost image preventing brush is increased, the discharge process from the brush is needed frequently or strongly, and the intended function cannot be attained. However, the transfer residue amount can be considerably reduced by using the developer of the invention, whereby the amount of the toner that is temporarily recovered to the ghost image preventing brushes 12a and 12b is small, and the discharge process from the brush can be easily attained, thereby allowing the maintenance of the cleanerless process for a prolonged period of time while retaining a high image quality.

The use of a contact-type image holding member charging device prevents the photoconductive layer of the photoconductor from being deteriorated with ozone, thereby prolonging the service life of the photoconductor. For example, a charging roller containing at least an elastic layer, such as ionically conductive rubber and carbon-dispersed rubber, and having a volume resistance of from 10⁴ to 10⁸ Ωcm is caused to contact the photoconductor under a constant pressure and to rotate following the rotation of the photoconductor, or to rotate at a velocity equivalent to or slightly different form that of the photoconductor. A DC voltage of from 400 to 1,000 V is applied to a core shaft of the charging roller, whereby charge is injected to the surface of the photoconductor, which is thus charged to a prescribed potential. There is a possibility that the transfer-residual toner remains on the photoconductor in the cleanerless process, or the back-transferred toner remains thereon in addition to the transfer-residual toner in the cleanerless tandem process, and therefore, the charging roller may be in contact consistently or on demand with a web, a brush, a blade, etc. for cleaning the charging roller.

In order to obviate the problem accompanied with the use of a contact-type image holding member-charging device of requiring a cleaning operation for removing the soil, it is also possible to use a non-contact-type image holding member-charging device. For example, a charging roller having a similar electrical resistance as in the contact type is disposed with a spacing of 20-100 μm from the image holding, and a DC voltage of 50-200 V is applied to the shaft of the charging member to cause a minute gap from the image holding, thereby uniformly charging the image holding member. Compared with the corona charging system, the discharge distance becomes shorter, so that less ozone is generated to reduce the deterioration of the image holding member. It is also possible to superpose an AC voltage with the DC voltage.

### (Setting of Image Holding Member and Toner)

According to the invention, each toner and the image holding member are set or selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm². More specifically, toners are attached to the image holding member (photoconductor) under conditions close to the actual developing conditions, and are measured with respect to attachment force and charging amount, and a toner that satisfies the above-mentioned condition is selected among them.

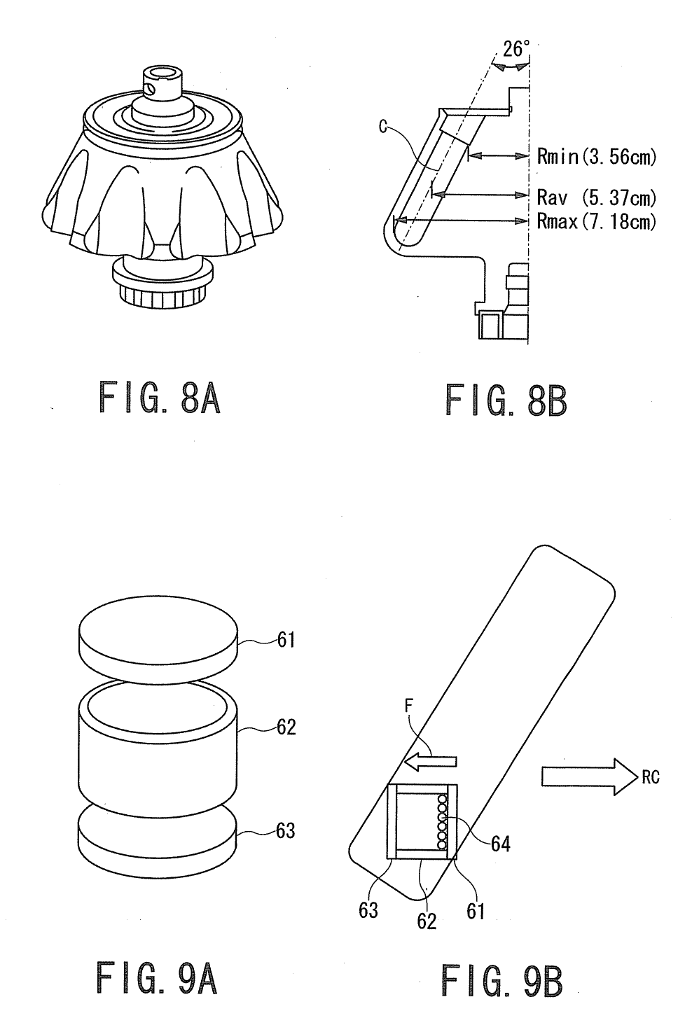

More specifically, as disclosed in JP-A-2002-328484, the attachment force is measured by using a centrifugal separator and adopting a system of calculation from a centrifugal force when the toner particles are detached from the attached substance. A centrifugal separator (“CP100MX” manufactured by Hitachi Koki Co., Ltd.) described in JP-A-2002-328484 may be used. The rotor has a structure shown in FIG. 8A (perspective view) and FIG. 8B (sectional view), and a cell is inserted in the C part thereof. The cell has a structure shown in FIG. 9A as an exploded view, and is composed of a sample attachment plate 61, a spacer 62 and a detached toner attachment plate 63. After a photoconductor sample 64 to which the toner particles have been attached under the development conditions is stuck to the inner face of the sample attachment plate 61, as shown in FIG. 9B, the photoconductor sample 64 is placed in each cell insertion part C of the rotor inclined to the rotational center RC such that the photoconductor sample 64 becomes parallel to the rotational center of the rotor.

A centrifugal acceleration RCF applied to the toner particles on the sample 64 placed in the cell by the rotation of the rotor is expressed by the following equation (1).

RCF=1.118×10⁻⁵×r×N²×g (3)

r: distance between the position of the sample placed and the rotational center [cm]

N: rotational speed [rpm]

g: gravitational acceleration [kgf]

Accordingly, when the weight of one toner particle is m [kg/particle], the centrifugal force F [N] applied to the toner particles is calculated from the following equations (4) and (5).

F=RCF×m (4)

m=(4/3)π×r³×ρ (5)

r: sphere-equivalent radius [cm]

ρ: toner specific gravity [kg/cm³]

In the measurement, (1) a sheet having a surface layer identical to that of the photoconductor to be measured for the attachment force is prepared. The photoconductor sheet may be used as such. However, in the case of a photoconductor having a laminate structure including a photoconductive layer (preferably composed of a charge transport layer and a charge generating layer) and a surface protective layer are laminated in this order, a sheet having the same surface layer as the surface protective layer may be used to obtain substantially the same measurement result. For a sample preparation, the photoconductive sheet is wrapped around an aluminum-based tube and placed at the position of the photoconductive drum while the photoconductive layer is grounded. Then, a sample toner is attached to the sheet surface under the development conditions at two levels of attached toner amounts including one of preferably from about 150 to 250 μg/cm² (an amount corresponding to one layer of toner particles or less) and another of to prepare sheet samples.

(2) Subsequently, each sheet sample to which the toner is attached is cut into a size corresponding to the sample attachment plate 61 and stuck to the plate 61 on the side thereof contacting the spacer 62 via a double-sided adhesive tape.

(3) The outer circumference diameters of the plates and 63 and the spacer 62 used in the following measurement example are 7 mm, respectively, the thickness and height of the tubular spacer 62 are 1 mm and 3 mm, respectively. As shown in FIG. 9B, the plate 61, the spacer 62 and the plate 63 are placed in the cell in this order such that the face of the plate 61 opposite to the face thereof carrying the sample faces the rotational center, the cell is placed in the angle rotor, and the angle rotor is mounted in the ultracentrifuge (not shown).

(4) After the ultracentrifuge is rotated at 10000 rpm, the plates 61 and 63 are taken out, and the toner particles attached to the respective plates are captured by transparent adhesive tapes, which are then applied on white paper to measure the reflection densities of the tapes by a Macbeth densitometer.

(5) Separately, a calibration formula of attached toner amount versus density of the tape is prepared, and the amount of the toner separated and the amount of the toner not separated are calculated per unit area with the formula.

(6) The same sheet having the toner attached thereto is cut similarly as described in (2) above and stuck to the plate 61, which is then set in an ultracentrifuge in the same manner as described in (3). After rotating the ultracentrifuge at 20,000 rpm, the plates 61 and 63 are taken out, and the amounts of the toner attached to the plates are measured. The above-mentioned operation is repeated while increasing the rotation speed up to 100,000 rpm.

(7) The centrifugal force F applied to the toner at the respective rotation speeds calculated by the formula of F=RCF×m (4) is multiplied by the proportion of the separated toner at each rotation speed, and the sum of all the calculated results is designated as an average attachment force F (N) between the toner and the photoconductor for the developer.

While the method of increasing the rotation speed of the ultracentrifuge from 10,000 rpm by 10,000 rpm has been described above, the measurement can be made by starting from 5,000 rpm and increasing by an increment of 5,000 rpm.

In the item (1) above, two levels are shown for the amount of the toner attached, and the smaller amount level may be selected so as to form approximately one layer while observing an attached toner sample through a microscope. When the amount is too small, the dynamic range of the reflection density of the image on the tape becomes too small to cause a large error on the calculation result of the ratio between the separated amount and non-separated amount, and thus the lower limit is desirably restricted to approximately 200 μg/cm². An amount exceeding one layer is selected for the larger amount level. When the amount is too large, the reflection density of the image on the tape is saturated so that an accurate conversion of the amount becomes difficult, and thus the upper is desirably restricted to approximately 500 μg/cm². The optimum measurement amounts may vary depending on the particle diameter of the toner particles. This is because the weight of the toner is naturally changed as the particle diameter is changed.

Three or more kinds of samples, including developing samples of at least two levels of developing amounts and a developing sample different in developing amount or charge amount, are desirably prepared to measure an average attachment force. The sample different in charge amount can be obtained, for example, by selecting immediately before and immediately after feeding the toner by acting the toner density controlling function of the developer. Alternatively, it may be obtained by preparing a developer having a toner concentration that is intentionally changed. By using the resulting three or more sets of data of the charge amount and the average attachment force, a charge amount q (C) per one particle is calculated from a cumulative 50% by number−average particle diameter (measured value by Coulter counter with a 100 μm aperture) and an average charge amount Q/M (average value based on charge amount distribution measured with E-Spart Analyzer), and a graph showing plots of the average attached amount versus q² is prepared. A linear approximation (1) is obtained based on the plots.

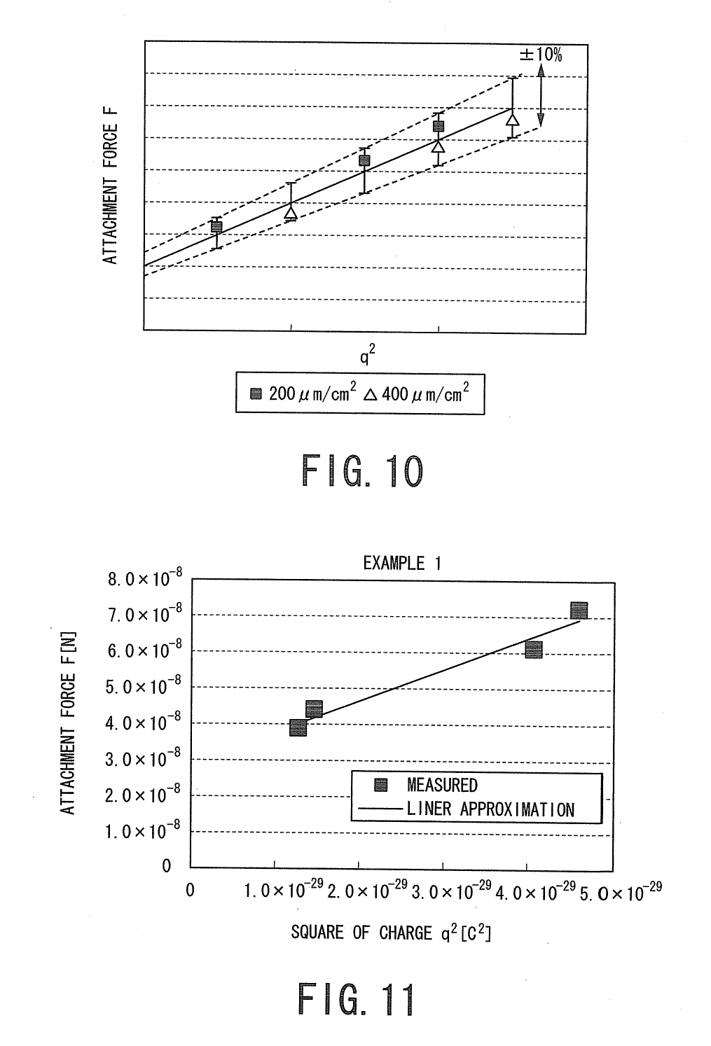

F=K×q²+F0 (1)

wherein K represents a proportionality factor, a Y-intercept (=F0) corresponds to a non-electrostatic attachment force. The F values obtained from the resultant linear approximation are compared with the measured value of the plots, and when the differences are 10% or less, the toner is selected for using. FIG. 10 is a graph showing an example of plots and linear approximation between the attachment force F and the square of the charge amount q² obtained in this manner with respect to a toner and a photosensitive member.

### EXAMPLES

### Example 1

20 wt.parts of Carmine 6B (pigment), 70 wt.parts of polyester resin and 10 wt.parts of rice wax were kneaded and coarsely pulverized to obtain colored resin particles. 20 wt.parts of the colored resin particles were dispersed together with 1 wt.part (as solid) of surfactant by means of a homogenizer exerting a mechanical sharing force to form a dispersion containing minute particles having an average particle diameter of 0.2 μm. The dispersion was then stirred while adding thereto 0.3 wt.part of hydrochloric acid and 0.3 wt.part of amine and heated to 70° C. to cause agglomeration and bonding up to about 5 μm.

Into the dispersion, 3.5 wt.parts of silica (RX200) having a primary particle diameter of 12 nm and 0.6 wt.part of titanium oxide (LU-227) were added, and the resultant dispersion was cooled down to room temperature under stirring, followed by filtration, washing with water and drying to obtain polyester resin-based toner base particles containing wax and pigment and carrying silica and titanium oxide fine particles uniformly attached to the surface thereof.

Thereafter, 1 wt.part of silica having a primary particle diameter of 100 nm was externally added by using a Henschel mixer, whereby toner particles A having a sphericity of 0.96, a 50% by number-average particle diameter (D50pop) of 6.2 μm and a ratio of a 50% by volume average particle diameter (D50vol) to D50pop of 1.13 were obtained. This toner exhibited good uniform dispersibility because the pigment was dispersed along with the resin in the dispersion. The wax was dispersed in the particles at an appropriate particle diameter, and while a portion of the wax was exposed to toner particle surfaces, no electrical disadvantage was caused thereby since the rice wax had a high volume resistivity comparable to the binder resin. As the wax exposed to the toner particle surfaces functioned as a lubricant to repel the external inorganic additive, so that the toner particles exhibited some degree of non-electrostatic attachment force. The toner particles having a narrow particle diameter distribution provided a relatively high packing density when disposed in multi-layers on the image holding member by development. Being blended with a carrier of silicone resin-coated ferrite particles having an average diameter of 40 μm at a toner concentration of 7 wt. %, the toner could be uniformly charged and exhibited a narrow attachment force distribution, thus also providing a narrow necessary transfer electric field distribution and a high transfer efficiency, because of excellent uniformity in particle diameter distribution and in dispersion of components in each particle. While the toner exhibited a high packing density in a still state, it also exhibited a high fluidity because of the external additive functioning as bearings. The resultant developer was carried by development at a weight of 200 μg/cm² on a photoconductive sheet used in a full color printing apparatus (“e-Studio 2500C”, made by Toshiba Tec Corporation), and the photoconductive sheet was wound about an aluminum pipe, to measure the average attachment force and the average charge amount. The developer was similarly carried by development on the photoconductive sheet also at a weight of 420 μg/cm², and the average attachment force and the average charge amount were measured in the same manner as above. Furthermore, a developer having a toner concentration of 8.5% by weight was prepared by using the same toner and carrier, and was subjected to measurement of an average attachment force (F) and an average charge amount (q) at developer weights of 230 μg/cm² and 430 μg/cm², respectively. The charge amount q per one particle was obtained from the average charge amount based on the values of a 50% by number-average particle diameter of 6.2 μm and a specific gravity of 1.2 g/cm³.

The measured values are shown in Table 1 below. The linear approximation of F and q² obtained from the plots was F=8.68×10²⁰×²+2.93×10⁻⁸, and the differences of the data from the linear approximation were as shown in Table 1 and were all within 10%. The plots and the linear approximation are shown in FIG. 11.

TABLE 1

| | Developer | Charge | | F | F | |
|---|---|---|---|---|---|---|
| | weight | amount Q/M | q² | (measured) | (calculated) | |
| Sample | (μg/cm²) | (−μC/g) | (C²) | (N) | (N) | Difference |
| 1 | 200 | 45.3 | 4.60 × 10⁻²⁹ | 7.25 × 10⁻⁸ | 6.92 × 10⁻⁸ | 4.71% |
| 2 | 420 | 42.7 | 4.09 × 10⁻²⁹ | 6.08 × 10⁻⁸ | 6.48 × 10⁻⁸ | −6.16% |
| 3 | 230 | 25.6 | 1.47 × 10⁻²⁹ | 4.41 × 10⁻⁸ | 4.21 × 10⁻⁸ | 4.86% |
| 4 | 430 | 23.9 | 1.28 × 10⁻²⁹ | 3.91 × 10⁻⁸ | 4.04 × 10⁻⁸ | −3.26% |

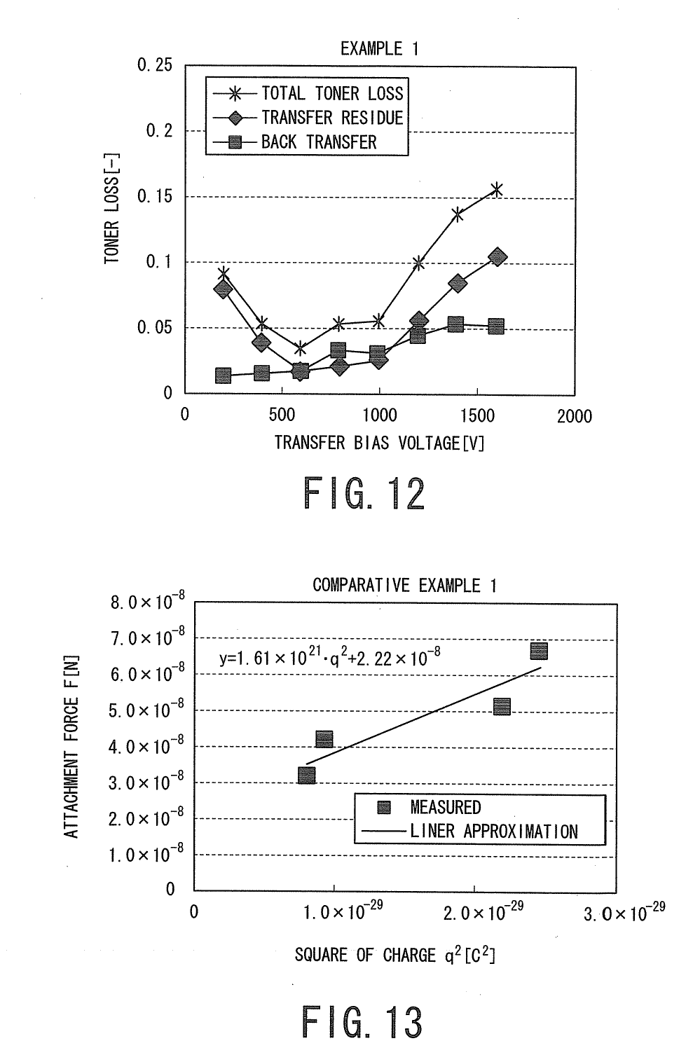

Developers of three colors of Y, C and K were further produced in a similar as the above-mentioned M developer, and the resultant four developers were charged in a tandem full color printing apparatus (“e-Studio 2500C”, made by Toshiba Tec Corporation) having the structure shown in FIG. 7 and containing photoconductors 1Y, 1M, 1C and 1K, of the same structure as described above for the measurement of attachment force and charge amount. The apparatus included an intermediate transfer belt, image holding member-cleaning members and an intermediate transfer belt-cleaning member, which are not shown in the figure, and a final transfer medium feeding mechanism, a secondary transfer mechanism and a fixing device, which are not shown in the figure. For obtaining a reflective density of 1.47 (M) with the apparatus and the toner, a developed toner amount of 500 μg/cm² was necessary. The transfer characteristics of the magenta toner measured by using the toner and the printing apparatus are shown in FIG. 12. When a bias voltage of 600 V was applied to the primary transfer roller, the transfer residue ratio and the back transfer ratio were each approximately 2%. (The transfer bias voltage was selected so as to minimize the total-value of the transfer residue ratio and the back transfer ratio, and when the same total values were obtained at plural transfer bias voltages, a transfer bias voltage giving a smaller back transfer ratio was selected.) Back transfer of the magenta toner occurred substantially similarly in the cyan unit and the black unit on the downstream side, so that the total value of the back transfer ratio and the transfer residue ratio (primary transfer loss ratio) was approximately 6%. As a result of similar evaluation, the primary transfer loss ratio of the yellow toner was approximately 8%, that of the cyan toner was 4%, and that of the black toner was approximately 2%. Transfer residue further occurred in secondary transfer since the intermediate transfer process was employed. The printing apparatus was subjected to a service life test of 30,000 sheets of full color images, and the transfer-residual toner and the back-transferred toner were totally recovered and weighed. The final average loss ratio of all the toners was approximately 6%, which was considerably small. The cleaning members were detached from the printing apparatus, and instead, transversely rubbing brushes 12a and 12b shown in FIG. 6 were attached to the image holding member, thereby allowing a simultaneous developing and recovering process. Upon performing a service life test of 30,000 sheets of full color images, image failure, such as a negative ghost image liable to occur due to inhibition of exposure and a positive ghost image liable to occur due to failure in recovery of the transfer-residual toner, did not occur, and image failure of fluctuation in color tone liable to occur due to mixing of toners of different colors was not observed either.

### Comparative Example 1

28 wt. % of polyester resin, 7 wt. % of Carmine 6B and 7 wt. % of rice wax were kneaded by an open roll continuous kneading granulator (“Kneadex”, made by K.K. YPK) and coarsely pulverized to produce a master batch, and 59% by weight of a polyester resin was added thereto and kneaded together. After coarse pulverization and fine pulverization, fractions of 7 μm or larger and 3 μm or smaller were cut off by an elbow jet classifier to provide magenta (M)-colored resin particles having a 50% by number-average particle diameter of 5.9 μm. To 100 wt. parts of the colored resin particles, 3 wt. parts of silica having a primary particle diameter of 12 nm was added, and the mixture was subjected to a mechano-chemical treatment (by means of “Hybridization System”, made by Nara Machinery Co., Ltd.), whereby edges formed by the pulverization were rounded to provide somewhat sphered base particles having a sphericity of 0.94. To 100 wt. parts of the base particles, 1 wt. part of silica having an average particle diameter of 12 nm (“R972”, made by Nippon Aerosil Co., Ltd.), 1.5 wt. parts of silica having an average particle diameter of 100 nm (“X-24”, made by Shin-Etsu Chemical Co., Ltd.) and 0.3 wt. part of titanium oxide (“NKT90”, made by Titan Kogyo, Ltd.) were attached to the surface of the base particles by using a Henschel mixer. The non-electrostatic attachment force of the toner was thus decreased by the effects of the sphering and the external additives. D50vol/D50pop of the toner was 1.18. The toner was mixed with a carrier of silicone resin-coated spherical ferrite particles having a volume-average particle diameter of 40 μm, thereby producing a developer. Samples 5 to 8 shown in Table 2 below were produced by changing the developing bias voltage and the mixing ratio of the toner and the carrier in combination with the same photosensitive member used in Example 1, and exhibited measurement results shown in Table 2 and FIG. 13.

TABLE 2

| | Developer | Charge | | F | F | |
|---|---|---|---|---|---|---|
| | weight | amount Q/M | q² | (measured) | (calculated) | |
| Sample | (μg/cm²) | (−μC/q) | (C²) | (N) | (N) | Difference |
| 5 | 180 | 38.5 | 2.47 × 10⁻²⁹ | 6.70 × 10⁻⁸ | 6.19 × 10⁻⁸ | 8.17% |
| 6 | 380 | 36.4 | 2.21 × 10⁻²⁹ | 5.13 × 10⁻⁸ | 5.77 × 10⁻⁸ | −11.13% |
| 7 | 210 | 23.8 | 9.43 × 10⁻³⁰ | 4.21 × 10⁻⁸ | 3.74 × 10⁻⁸ | 12.61% |
| 8 | 390 | 22 | 8.06 × 10⁻³⁰ | 3.19 × 10⁻⁸ | 3.52 × 10⁻⁸ | −9.31% |

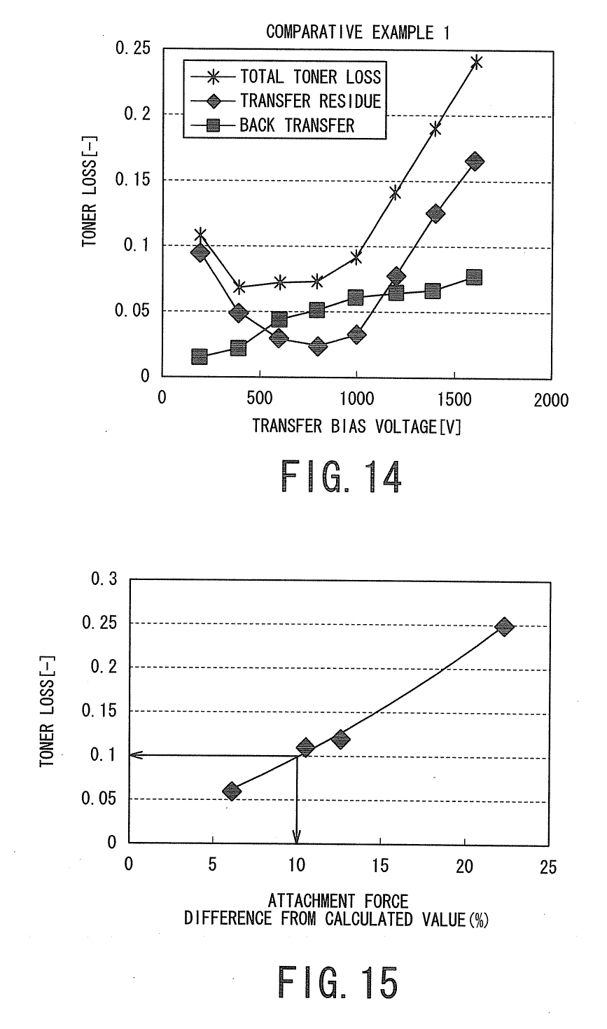

As shown in Table 2, the difference from the linear approximation exceeded 10% in Samples 6 and 7. Developing agents of four colors of Y, M, C and K were produced in the same production method of the above-mentioned developer, and were installed in a tandem full color printing apparatus having the structure shown in FIG. 7 in the same manner as in Example 1. For obtaining a reflective density of 1.47 (M) with the apparatus and the toner, a toner developed amount of 550 μg/cm² was necessary. The transfer characteristics of the magenta toner upon using the toner and the printing apparatus are shown in FIG. 14. When a bias voltage of 400 V was applied to a primary transfer roller, the transfer residue ratio was approximately 5%, and the back transfer ratio was approximately 2.5%. (The transfer bias voltage was selected so as to minimize the total value of the transfer residue ratio and the back transfer ratio, and when the same total values were obtained at plural transfer bias voltages, a transfer bias voltage giving a smaller back transfer ratio was selected.) Back transfer of the magenta toner occurred substantially similarly in the cyan unit and the black unit on the downstream side, and thus the total value of the back transfer ratio and the transfer residue ratio (primary transfer loss ratio) was approximately 10%. Upon evaluating similarly, the primary transfer loss ratio of the yellow toner was approximately 12.5%, that of the cyan toner was 7.5%, and that of the black toner was approximately 5%. Transfer residue further occurred upon secondary transfer since the intermediate transfer process was employed. The printing apparatus was subjected to a service life test of 30,000 sheets of full color images, and the transfer-residual toner and the back-transferred toner were totally recovered and weighed. The final average loss ratio of all the toners was approximately 12%, which was twice the value in Example 1. The cleaning member was detached from the printing apparatus, and instead, transversely rubbing brushes were attached to the image holding member, thereby allowing a simultaneous developing and recovering process. Upon performing a service life test of 30,000 sheets of full color images, image failure of a negative ghost image occurring due to inhibition of exposure occurred after approximately 10,000 sheets, and image failure of a positive ghost image occurring due to failure in recovery of the transfer-residual toner occurred after approximately 18,000 sheets. Toners of different colors were mixed in the developing device due to back transfer, and upon printing full color images with the same image data on 30,000 sheets, the color tone was changed from the initial stage, for example, a solid cyan image at an initial density of 1.45 caused a color difference ΔE of 23 compared with the initial image after 30,000 sheets to provide a different color of blue green. The color difference ΔE was calculated from color values measured by using an X-Rite color checker including a D50 light source at a viewing angle of 2° and the L′a′b′ colorimetric system.

### Example 2

Toners and developers were prepared and evaluated in the same manner as in Example 1 except for omission of the encapsulation with the silica (RX200) and titanium oxide (LU-227) during production of toner base particles.

### Comparative Example 2

Toners and developers were prepared and evaluated in the same manner as in Comparative Example 1 except for omission of the sphering treatment after the pulverization during production of toner base particles.

### Comparative Example 3

Toners and developers were prepared and evaluated in the same manner as in Example 1 except for omission of the addition of the rice wax during production of toner base particles.

### Comparative Example 4

Toners and developers were prepared and evaluated in the same manner as in Example 1 except that the temperature for the agglomeration and bonding of dine particles was raised from 70° C. to 80° C. during production of toner base particles.

The toners and developers prepared in the above Example 2 and Comparative Examples 2-4 were evaluated in the same manner as in Example 1 and Comparative Example 1 with respect to attachment force characteristics and transfer characteristics. Summary evaluation results for all Examples and Comparative Examples are inclusively shown in the following Table 3.

TABLE 3

| | Attachment force: | |
|---|---|---|
| | maximum difference | Final toner |
| | from linear | loss ratio |
| | approximation (%) | (—) |
| Example 1 | 6.16 | 0.06 |
| Example 2 | 8.22 | 0.095 |
| Comparative Example 1 | 12.61 | 0.12 |
| Comparative Example 2 | 22.30 | 0.25 |
| Comparative Example 3 | 29.50 | 0.27 |
| Comparative Example 4 | 10.55 | 0.11 |

In Table 3, the term “attachment force: maximum difference from linear approximation (%)” means the maximum value among four points of data of difference/calculated value (%), wherein the difference is between the measured value of attachment force and the calculated value of attachment force based on the linear approximation (1) obtained from the relationship between square of the charge amount and the average attachment force measured while varying the developer weight and charge amount. The term “final toner loss ratio (−)” means the loss ratio (−) in total of the transfer-residual toner and the back-transferred toner with respect to the total toner upon performing a service life test of full color images of 30,000 sheets. It is understood from the data that the toner loss ratio (−) was smaller when the difference from the approximate expression was smaller, and the difference in attachment force from the linear approximation should be 10% or less in order to achieve a toner loss ratio (−) of 0.1 or less. FIG. 15 is a graph showing the plots of the toner loss ratio (−) with respect to the difference in attachment force from the linear approximation (%).

When the inclination K of the approximate expression (1) obtained by plotting q² (square of charge amount per one toner particle) on the abscissa and F (average attachment force of toner to photoconductor) on the ordinate is smaller, a ratio a/r in the following formula (2) is smaller, and when the slope K of the linear approximation (1) is larger, the a/r is also larger.

$${F}_{e} = \frac{{ɛ}^{′} - 1}{{ɛ}^{′} + 1} \cdot \frac{{q}^{2} {r}^{2}}{4 π {{ɛ}_{0} ( {r}^{2} - {a}^{2} )}^{2}} \qquad ( 2 )$$

wherein ∈′ represents a relative dielectric constant of the image holding member, q represents a charge amount (C) per one particle of the toner, and r represents a 50% number average radius of the toner (m).

Based on the data obtained in Examples and Comparative Examples above, the inclination (or slope) K of the linear approximation (1), the radius r of the toner particles and the relative dielectric constant ∈′ of the surface of the photoconductor are substituted in the expression (2), and the value a is calculated for obtaining a/r. When the relative dielectric constant of the photoconductor is 3.3, the toner of Example 2 having an average particle diameter of 5.30 μm and the slope of the linear approximation of 4.08×10²¹ provides a/r of 0.77. The particle diameters, the sphericity, the slope of the linear approximation and the values a/r of the toners were obtained for Examples 1 and Comparative Examples, and the ranges of transfer bias voltage where the transfer residue ratio became 5% or less (i.e., a primary transfer ratio of 95% or more) were obtained. The results are shown in Table 4.

TABLE 4

| | | | | | Range of bias |
|---|---|---|---|---|---|
| | Particle | | Slope of linear | | voltage for primary |
| | diameter | Sphericity | approximation | a/r | transfer ratio of 95% |
| | (×10⁻⁶m) | (—) | (N/C²) | (—) | or more (V) |
| Example 1 | 6.20 | 0.96 | 7.68 × 10²⁰ | 0.49 | 850 |
| Example 2 | 5.30 | 0.96 | 4.08 × 10²¹ | 0.77 | 500 |
| Comparative | 5.90 | 0.94 | 1.61 × 10²¹ | 0.64 | 700 |
| Example 1 | | | | | |
| Comparative | 5.25 | 0.92 | 1.17 × 10²² | 0.87 | 300 |
| Example 2 | | | | | |
| Comparative | 6.50 | 0.985 | 6.04 × 10²⁰ | 0.36 | — |
| Example 3 | | | | | |
| Comparative | 5.50⁶ | 0.975 | 9.14 × 10²⁰ | 0.41 | 870 |
| Example 4 | | | | | |

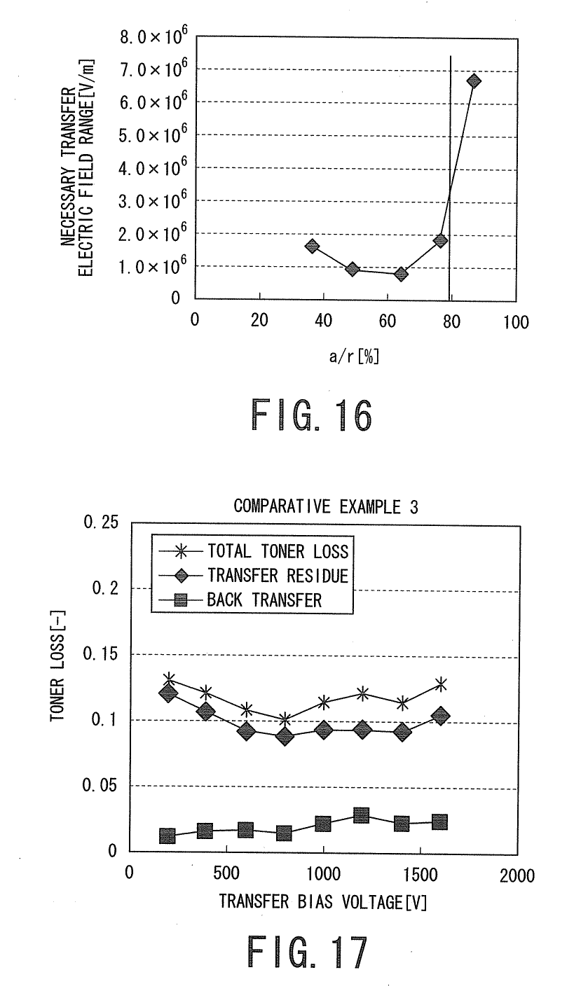

When the value a/r is large, the fluctuation amount of the necessary transfer electric field upon changing the toner charge amount is large, whereby the optimum condition for transfer is changed as the toner charge amount is changed due to environmental change or change with time, and thus it is difficult to minimize the amount of the toner lost by transfer residue and back transfer. In the case of a full color printing apparatus, since toner images of plural colors are superposed on an intermediate transfer belt or a final transfer medium, the toner of the preceding step receives the transfer bias upon transferring the toner of the subsequent step, thereby providing a high possibility of changing the toner charge amount by the number of the transfer bias received. Accordingly, in the secondary transferring step of from the intermediate transfer member to the final transfer medium, it is necessary to transfer the toners with different charge amounts under one set of transfer conditions. FIG. 16 is a graph obtained by calculating the necessary transfer electric field range (maximum value of the necessary transfer electric field−minimum value thereof) in a manner as described below while setting the toner charge amount to a range of ±10 μC/g of the optimum value, and plotting it against a/r on the abscissa with respect to the toners (developers) shown in Table 4. It is understood that when a/r exceeds 80%, the necessary transfer electric field range is increased suddenly.

### <Necessary Transfer Electric Field>

Necessary transfer electric field E is obtained by a formula of E=F/q (wherein F denotes a toner attachment force, and q denotes a charge amount per 1 toner particle). From the linear approximation of F=K×q²+F0 . . . (1), the values of K and F0 for each toner are obtained. Upper and lower limits of q are determined from cumulative 10% and 90% values of q/d based on distribution data measured by E-Spart Analyzer (d: toner particle size measured by Coulter counter), which are respectively multiplied by a number-average diameter of d to provide an upper and a lower limit of q. Necessary transfer electric fields E are obtained in a range between the upper and lower limits of q to determine an upper limit and a lower limit of E. In this instance, the upper or lower limit of q does not necessarily provide an upper or lower limit of E since E=F/q=F=K×q+F0/q assumes a minimum value in the range of q.

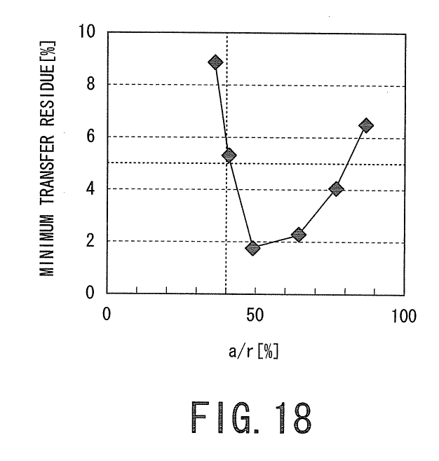

In the case where the slope K is so small as to provide a/r=0.36 as in Comparative Example 3, the transfer efficiency does not remarkably change upon changing the transfer bias, and there is found no condition giving small transfer residue while the back transfer amount is small, as shown in FIG. 17. This is because the contribution of the non-electrostatic attachment force to the attachment force is larger than the electrostatic attachment force, and the force of moving the toner particles does not occur even when an electric field is applied. FIG. 18 shows a relationship between a/r and the minimum transfer residue ratio. It is understood that a/r is desirably from 0.4 to 0.8 for suppressing the transfer residue ratio to 5% or less.

As described above, according to the invention, there is provided an image forming method is provided with improved controllability of transfer property by an electric field and capable of suppressing transfer residue and back transfer of a toner, by taking change in an attachment force accompanying change in a charge amount of the toner into consideration and based thereon, by setting the relationship between the charge amount of the toner and change in the attachment force within a limited range even though the development level varies, and an apparatus for the image forming method is also provided. According to a preferred embodiment of the invention, when the value a/r showing the intensity of influence of the charge amount to the attachment force is controlled in an appropriate range, the latitude of transfer conditions is enlarged, and when the attachment force between the toner layers is made nearly equal to the attachment force between the toner and the photoconductor, the total amount of the toner that is lost by transfer residue and back transfer can be decreased, whereby favorable transfer characteristics can be maintained for a long period of time.

What is claimed is:

1. An electrophotographic color image forming method comprising: forming a color image by transferring and superimposing toners of plural colors in a non-fixed state from an image holding member to an intermediate transfer member or a final transfer medium, wherein each toner and the image holding member are selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm².

2. The method according to claim 1, wherein each toner and the image holding member are selected to further satisfy a relationship of 0.4≦a/r≦0.8 where an average value Fe of an electrostatic attachment force between the image holding member and the toner is expressed by a following formula (2):
$${F}_{e} = \frac{{ɛ}^{′} - 1}{{ɛ}^{′} + 1} \cdot \frac{{q}^{2} {r}^{2}}{4 π {{ɛ}_{0} ( {r}^{2} - {a}^{2} )}^{2}} \qquad ( 2 )$$
wherein ∈′ represents a relative dielectric constant of the image holding member, q represents a charge amount (C) per one particle of the toner, and r represents a 50% by number-average radius of the toner (m).

3. A color image forming apparatus comprising a rotating image holding member, and a charging unit, an imagewise exposing unit, developing units and a transferring unit that are disposed around the image holding member in this order; the developing units including Y, M, C and K developing units that form Y, M, C and K toner images, respectively, by developing electrostatic images on the image holding member with Y, M, C and K toners in association with rotation of the developing unit and the image holding member; wherein each toner and the image holding member are selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm².

4. The apparatus according to claim 3, wherein each toner and the image holding member are selected to further satisfy a relationship of 0.4≦a/r≦0.8 where an average value Fe of an electrostatic attachment force between the image holding member and the toner is expressed by a following formula (2):
$${F}_{e} = \frac{{ɛ}^{′} - 1}{{ɛ}^{′} + 1} \cdot \frac{{q}^{2} {r}^{2}}{4 π {{ɛ}_{0} ( {r}^{2} - {a}^{2} )}^{2}} \qquad ( 2 )$$
wherein ∈′ represents a relative dielectric constant of the image holding member, q represents a charge amount (C) per one particle of the toner, and r represents a 50% by number-average radius of the toner (m).

5. A color image forming apparatus comprising four image forming units including a Y image forming unit, an M image forming unit, a C image forming unit and a K image forming unit, and a transferring unit; each image forming unit including an image holding member, a charging unit, an imagewise exposing unit and a developing unit for forming a toner image of a corresponding color on the image holding member; the transferring units transferring and superposing Y, M, C and K toner images, which are formed on the respective image holding members, in a non-fixed state onto a transfer medium; and in each of the image forming units, the toner and the image holding member are selected to provide plots of attachment force F [C] between the toner and the image holding member versus square of charges q² [C2] giving a linear approximation of F=K×q²+F0 . . . (1) (wherein K denotes a proportionality factor and F0 denotes an intercept), so that plotted values of F fall within a range of ±10% of F given by the linear approximation in a range of attached toner amount on the image holding member of 150 to 600 μg/cm².

6. The apparatus according to claim 5, wherein in each of the image forming units, the toner and the image holding member are selected to further satisfy a relationship of 0.4≦a/r≦0.8 where an average value Fe of an electrostatic attachment force between the image holding member and the toner is expressed by a following formula (2):
$${F}_{e} = \frac{{ɛ}^{′} - 1}{{ɛ}^{′} + 1} \cdot \frac{{q}^{2} {r}^{2}}{4 π {{ɛ}_{0} ( {r}^{2} - {a}^{2} )}^{2}} \qquad ( 2 )$$
wherein ∈′ represents a relative dielectric constant of the image holding member, q represents a charge amount (C) per one particle of the toner, and r represents a 50% by number-average radius of the toner (m).
